(19) United States
(12) Patent Application Publication
(10) Pub. No.: US 2025/0038230 A1
(43) Pub. Date: Jan. 30, 2025

(54) FUEL CELL SYSTEM AND METHOD FOR OPERATING A FUEL CELL SYSTEM

(71) Applicant: Robert Bosch GmbH, Stuttgart (DE)

(72) Inventors: Christopher Bruns, Sindelfingen (DE); Kristoffer Kantschar, Ludwigsburg (DE); Simon Buehler, Stuttgart (DE); Timo Bosch, Renningen (DE); Tobias Falkenau, Esslingen (DE); Sven Georg Butschek, Ludwigsburg / Neckarweihingen (DE)

(21) Appl. No.: 18/716,586

(22) PCT Filed: Dec. 8, 2022
(86) PCT No.: PCT/EP2022/084929

§ 371 Date: Jun. 5, 2024

(30) Foreign Application Priority Data
Dec. 14, 2021 (DE) 10 2021 214 304.0

(51) Int. Cl. H01M 8/04089; H01M 8/04223; H01M 8/04298; H01M 8/0438; H01M 8/04537; H01M 8/04992

(52) U.S. Cl. CPC H01M 8/04097; H01M 8/04231; H01M 8/04305; H01M 8/04425; H01M 8/04537; H01M 8/04992

(57) ABSTRACT

The present invention relates to a method for operating a target fuel cell system (200), to a fuel cell system (200) having a control apparatus (201) and to a computer program product containing program code means according to the appended claims.

### BACKGROUND

The present invention relates to a method for operating a fuel cell system, a fuel cell system, and a computer program product.

Polymer electrolyte membrane (PEM) fuel cell systems convert hydrogen by means of oxygen into electrical energy, generating waste heat and water.

A PEM fuel cell consists of an anode supplied with hydrogen, a cathode supplied with air, and a polymer electrolyte membrane placed between the two, where air and oxygen are converted into electricity, water, and heat. A plurality of such fuel cells are typically stacked to form a fuel cell stack in order to maximize an electrically generated voltage.

A systemic approach for supplying hydrogen to the PEM anode has been established, in which still hydrogen-rich anode exhaust gas is again supplied to an anode entry by gas conveying units together with fresh hydrogen, which is known as recirculation.

A sufficiently high hydrogen concentration at the anode inlet of a fuel cell stack ensures that a catalyst in the fuel cell stack is supplied with sufficient hydrogen over an entire flow range.

Nitrogen, which passes from a cathode side to an anode side through diffusion processes, represents an inert gas for electrochemical reactions taking place in a fuel cell. The recirculation causes nitrogen to accumulate on the anode side so that less hydrogen can be supplied to the anode. The hydrogen concentration drops accordingly, which can lead to a reduction in cell voltage.

If a fuel cell is no longer sufficiently supplied with hydrogen, this can damage the fuel cell. From time to time, some of the gas in a recirculation chamber is therefore discharged via a purge valve and displaced by fresh hydrogen. Such a purging process, i.e. so-called “purging”, makes it possible to reduce the nitrogen concentration on the anode side and thus increase the hydrogen concentration again. If discharged frequently, the hydrogen concentration is kept high and the nitrogen concentration correspondingly low. However, this also wastes fuel and reduces system efficiency.

Knowledge of the current hydrogen concentration value is therefore important in order to optimize the frequency of rejection with regard to system efficiency. Hydrogen sensors installed in the anode path can be used to ascertain the hydrogen concentration. However, these sensors always interfere with an anode path, which is associated with mechanical interfaces.

Mechanical interfaces can in turn cause leaks. In addition, hydrogen sensors are expensive, have a low service life in automotive applications and are barely available.

### SUMMARY

Presented in the context of the invention are a method, a fuel cell system, and a computer program product for operating the fuel cell system. Further features and details of the invention arise from the respective dependent claims, the description, and the drawings. In this context, features and details described in connection with the method according to the invention clearly also apply in connection with the fuel cell system according to the invention as well as the computer program product according to the invention, and respectively vice versa so that, with respect to the disclosure, mutual reference to the individual aspects of the invention is or can always be made.

The invention presented serves to efficiently operate a fuel cell system. In particular, the invention presented serves to operate a fuel cell system without a physical hydrogen concentration sensor on the anode side or in the anode circuit.

Thus, according to a first aspect of the presented invention, a method for operating or running a fuel cell system is presented.

The presented method comprises a training step in which a machine learning system is trained by means of a training fuel cell system to ascertain a hydrogen concentration supplied through an inlet valve of the training fuel cell system to a fuel cell stack of the training fuel cell system. Herein the machine learning system receives as input signals at least one operating parameter of a recirculation fan of the training fuel cell system and one state parameter for an electrical state of the fuel cell stack of the training fuel cell system.

Furthermore, in the method presented, a hydrogen concentration ascertained by the machine learning system is validated using a hydrogen concentration ascertained by a hydrogen concentration sensor of the training fuel cell system.

Furthermore, the presented method comprises a transfer step, in which the machine learning system trained by means of the training fuel cell system is at least partially transferred, in particular a data model, into a target fuel cell system, an ascertaining step, in which, for example, hydrogen concentration supplied to a fuel cell stack of the target fuel cell system through an inlet valve and/or a recirculation of the target fuel cell system is ascertained by means of the machine learning system, a determination step, in which an activation interval between respective activations of a purge valve of the target fuel cell system is determined based on the hydrogen concentration determined in the determination step, wherein the machine learning system receives at least one operating parameter of a recirculation fan of the target fuel cell system and one state parameter of an electrical state of the fuel cell stack of the target fuel cell system as input signals, and a setting step in which the activation interval and/or discharged current determined in the determination step is set in the target fuel cell system for operating the target fuel cell system.

In the context of the invention presented, the expression “training of a machine learning system” is understood to mean a process in which a mathematical model on which the machine learning system is based is changed until a specified target, e.g., a minimum deviation between a result of the model and a corresponding measured value of a hydrogen concentration in the training fuel cell system ascertained by the hydrogen concentration sensor provided according to the invention, is achieved.

In the context of the invention presented herein, the expression “validation of a machine learning system” means a process in which initial values ascertained by the machine learning system are compared with measured values.

The method presented is based on a machine learning system, such as an artificial neural network or a support vector machine, which is trained under controlled conditions, in particular in a laboratory environment, and validated using measured values of a hydrogen concentration in a training fuel cell system ascertained by means of a hydrogen concentration sensor. Based on the measured values ascertained by the hydrogen concentration sensor, the accuracy of the machine learning system for ascertaining the hydrogen concentration in the anode circuit of the training fuel cell system can be validated and successively improved accordingly.

As soon as the machine learning system has been sufficiently trained so that, for example, a deviation between a value of a hydrogen concentration in the anode circuit of the training fuel cell system ascertained by the machine learning system and a hydrogen concentration measured by means of the hydrogen concentration sensor is minimal or less than a predetermined threshold value, the machine learning system is used in a target fuel cell system that does not comprise a hydrogen concentration sensor.

In the target fuel cell system, the machine learning system or its data model is used to ascertain a hydrogen concentration in an anode circuit of the target fuel cell system, so that a purge valve of the target fuel cell system can be set or operated depending on the hydrogen concentration ascertained by the machine learning system.

Since the machine learning system provided according to the invention has been or is trained using hydrogen concentration values ascertained by means of a hydrogen concentration sensor in order to interpret respective input values, the machine learning system, when fully trained, is suitable for operating a target fuel cell system without a hydrogen concentration sensor. This means that the trained machine learning system comprises a mathematical model or a data model of correlations between respective input values and a resulting hydrogen concentration, which comprises all operating states of the training fuel cell system carried out during the training step and, as a result, can be used to control or regulate the target fuel cell system without a hydrogen concentration sensor.

In experiments, the input values for the machine learning system have in particular been operating parameters of a recirculation fan of a respective fuel cell system, such as a power and/or a speed of the recirculation fan, a state parameter of an electrical state of a fuel cell stack, such as a voltage and/or an electrical current on the fuel cell stack, a state parameter of a respective fuel cell system, such as the system pressure, and a parameter of an amount of hydrogen supplied to the fuel cell stack through an inlet valve, which is determined, for example, by an activity of a pump, an electrical current supplied to the inlet valve, or a flow rate sensor can be proven suitable.

The operating point of a fuel cell system is usually defined by the electrical current it generates. The more electricity is generated, the more hydrogen is consumed and must therefore be added to the anode circuit via a metering valve. At the same time, nitrogen diffuses into the anode circuit via the fuel cell stack, so that anode gas must be purged out of the anode circuit. During operation, this results in a hydrogen concentration in the anode circuit which, due to its specific gas composition and a corresponding anode pressure, also specifies an operating point of a gas delivery unit, such as a recirculation fan of a corresponding fuel cell system.

Using the trained machine learning system, a respective fuel cell system can be controlled or regulated in that a purge valve of the fuel cell system is activated as a function of an output signal of the machine learning system and, as a result, as a function of a change in the input values of the machine learning system, i.e., dynamically, and is not operated with a rigid or predetermined activation interval.

Dynamic activation of a purge valve using the machine learning system provided according to the invention can minimize the discharge of fresh hydrogen in particular, so that a fuel cell system operated accordingly works particularly efficiently.

It may be provided that the machine learning system comprises a data model that mathematically maps a relationship between the input signals and a hydrogen concentration in the anode circuit of the training fuel cell system ascertained by means of the hydrogen concentration sensor.

The data model can, for example, be a mathematical formula that mathematically maps a relationship between an electric current generated by a respective fuel cell stack and a hydrogen concentration, and which comprises a correction term that changes during the training of the machine learning system. In particular, the data model can comprise a distribution function, such as a Gaussian distribution, whose parameters are adapted during the training of the machine learning system.

Accordingly, only the data model or a so-called “kernel” can be transferred to the respective target fuel cell system in order to transfer the machine learning system. The data model can comprise, for example, a Gaussian distribution or an artificial neural network.

It may further be provided that the machine learning system is configured to automatically adapt the data model during the training step such that a deviation between a value of a hydrogen concentration in the anode circuit of the training fuel cell system ascertained by the machine learning system and a hydrogen concentration measured by the hydrogen concentration sensor is minimized or minimized.

A machine learning system whose underlying data model is adapted such that a deviation between a value of a hydrogen concentration in the anode circuit of a respective training fuel cell system ascertained by the machine learning system and a hydrogen concentration measured by a hydrogen concentration sensor of the training fuel cell system is minimized can be used to replace a hydrogen concentration sensor or to operate a target fuel cell system that does not have a hydrogen concentration sensor and is therefore particularly robust against leakages.

Accordingly, it may be envisaged that the method presented is carried out in the target fuel cell system without a hydrogen concentration sensor. This means that the trained machine learning system can replace a physical hydrogen concentration sensor in a target fuel cell system.

It can also be provided that the machine learning system is also provided with measured values of a pressure and/or a temperature in the anode circuit as well as a quantity of hydrogen purged out during the last purging process as input signals.

Since the operating parameters of a pressure and/or a temperature in the anode circuit and a quantity of hydrogen or “purge time” or “purge quantity” purged out during a recently performed purging process have a direct influence on a hydrogen concentration present in the anode circuit, a machine learning system trained using these additional operating parameters leads to a particularly accurate ascertaining of a hydrogen concentration present in an anode path of a respective target fuel cell system.

In a second aspect, the presented invention relates to a target fuel cell system with a control apparatus. The control apparatus is configured to execute at least a part, in particular a data model, of a machine learning system which has been trained in a training step by means of a training fuel cell system to ascertain a hydrogen concentration supplied by an inlet valve of the training fuel cell system to a fuel cell stack of the training fuel cell system on the basis of input signals, wherein the input signals comprise at least an operating parameter of a recirculation fan of the training fuel cell system and a state parameter of an electrical state of the fuel cell stack of the training fuel cell system, and the hydrogen concentration ascertained by the machine learning system has been validated against a hydrogen concentration ascertained by a hydrogen concentration sensor of the training fuel cell system.

The machine learning system is configured to ascertain a hydrogen concentration supplied to a fuel cell stack of the target fuel cell system by, for example, an inlet valve and/or a recirculation system of the fuel cell system, wherein the machine learning system receives as input signals at least an operating parameter of a recirculation fan of the fuel cell system and a state parameter of an electrical state of the fuel cell stack of the fuel cell system.

The control apparatus is further configured to determine an activation interval between respective activations of a purge valve of the fuel cell system based on the hydrogen concentration ascertained by the machine learning system, and to set the determined activation interval in the fuel cell system.

The method presented is particularly useful for operating the fuel cell system presented. Accordingly, the fuel cell system presented is based on a machine learning system that has been trained according to the method presented.

Since the machine learning system provided according to the invention is based on a data model that has been validated using data measured by a hydrogen concentration sensor, the machine learning system can replace the action of a physical hydrogen concentration sensor without the need for a mechanical interface that could lead to leakage.

It may further be provided that the machine learning system is configured to ascertain a hydrogen concentration based on the input signals, and that the control apparatus is configured to set the activation interval depending on the ascertained hydrogen concentration.

To ascertain a hydrogen concentration, the machine learning system can comprise a data model that is modified during training and that assigns the corresponding hydrogen concentration to the respective input values. Hydrogen concentrations ascertained in this way can in turn be assigned corresponding values or control signals for an activation interval, i.e. a period between two activation cycles of a purge valve, for example using an assignment table.

In a third aspect, the presented invention relates to a computer program product comprising program code means which, when executed on a computer, configures the computer to perform the steps of a possible embodiment of the presented method.

In the context of the invention presented, the expression “computer or control apparatus” is understood to mean a processor, a microcontroller, or any other programmable circuit.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 one possible embodiment of the method presented,

FIG. 2 one possible embodiment of the presented fuel cell system.

### DETAILED DESCRIPTION

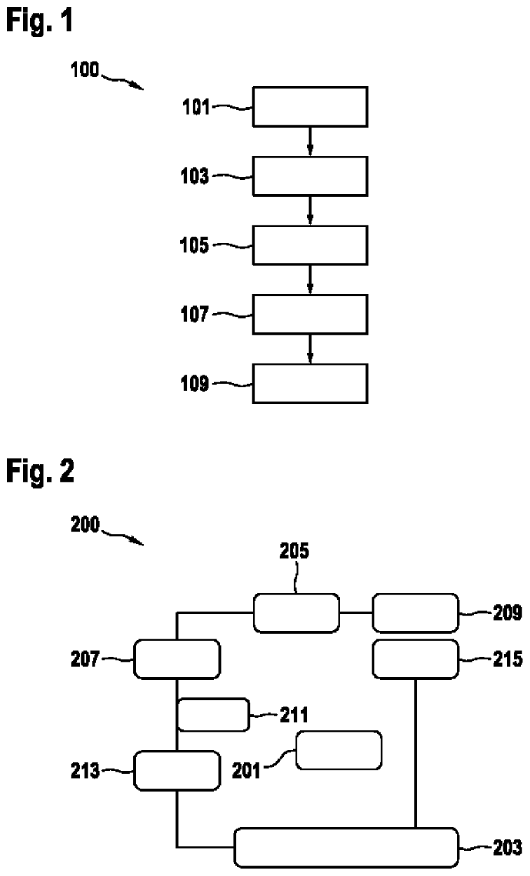

A method 100 for operating a fuel cell system is shown in FIG. 1.

The presented method 100 comprises a training step 101 in which a machine learning system is trained by means of a training fuel cell system to ascertain a hydrogen concentration supplied by, for example, an inlet valve of the training fuel cell system and/or a recirculation to a fuel cell stack of the training fuel cell system. Herein the machine learning system receives as input signals at least one operating parameter of a recirculation fan (205) of the training fuel cell system and one state parameter for an electrical state of the fuel cell stack (203) of the training fuel cell system.

Furthermore, in the method presented, a hydrogen concentration ascertained by the machine learning system is validated using a hydrogen concentration ascertained by a hydrogen concentration sensor of the training fuel cell system.

Furthermore, the presented method comprises a transfer step 103, in which the machine learning system trained by means of the training fuel cell system is at least partially transferred, in particular its data model, into a target fuel cell system, an ascertaining step 105, in which, for example, hydrogen concentration supplied to a fuel cell stack of the target fuel cell system through an inlet valve and/or a recirculation of the target fuel cell system is ascertained by means of the machine learning system, a determination step 107, in which an activation interval between respective activations of a purge valve of the target fuel cell system is determined based on the hydrogen concentration determined in the determination step, wherein the machine learning system receives at least one operating parameter of a recirculation fan of the target fuel cell system and one state parameter of an electrical state of the fuel cell stack of the target fuel cell system as input signals, and a setting step 109 in which the activation interval determined in the determination step 107 is set in the target fuel cell system for operating the target fuel cell system.

Since in the training step 101 the machine learning system is trained, in particular validated, using measured values ascertained by a hydrogen concentration sensor, the trained machine learning system can replace the effect of a physical hydrogen concentration sensor, for example by mathematically modeling or mapping the hydrogen concentration sensor.

By setting the purge valve depending on a hydrogen concentration ascertained by the machine learning system, an activation interval can be selected specifically so that the ascertained hydrogen concentration changes to a predetermined hydrogen concentration. Accordingly, a predetermined activation interval, which is usually designed for a minimum hydrogen concentration, can be dispensed with, so that the activation interval can be dynamically adapted, in particular shortened.

FIG. 2 shows a fuel cell system 200. The fuel cell system 200 comprises a control apparatus 201, a fuel cell stack 203, a recirculation fan 205, a purge valve 207, and an inlet valve 209 for metering fresh hydrogen from a tank and the fuel cell stack 203.

The fuel cell system 200 optionally comprises a water separator 211, a drain valve 213, and a jet pump 215 for setting a pressure in the fuel cell stack 203.

The control apparatus 201 is configured to execute a machine learning system trained according to the method 100. Accordingly, the control apparatus 201 controls the purge valve 207 by means of the machine learning system depending on operating parameters of the recirculation fan 205 and a state parameter of an electrical state of the fuel cell stack 203, so that the fuel cell system 200 does not comprise a physical hydrogen concentration sensor.

1. A method (100) of operating a target fuel cell system (200), wherein the method (100) comprises:
a training step (101) in which a machine learning system is trained by means of a training fuel cell system to ascertain a hydrogen concentration supplied to a fuel cell stack of the training fuel cell system,
wherein the machine learning system receives as input signals at least one operating parameter of a recirculation fan of the training fuel cell system and one state parameter for an electrical state of the fuel cell stack of the training fuel cell system.
and in which a hydrogen concentration ascertained by the machine learning system is validated using a hydrogen concentration ascertained by a hydrogen concentration sensor of the training fuel cell system,
a transfer step (103) in which the machine learning system trained by means of the training fuel cell system is at least partially transferred to a target fuel cell system,
an ascertaining step (105) in which a hydrogen concentration supplied to a fuel cell stack of the target fuel cell system is ascertained by means of the machine learning system,
a determination step (107) in which an activation interval between respective activations of a purge valve (207) of the target fuel cell system (200) is determined on the basis of the hydrogen concentration determined in the determination step,
wherein the machine learning system receives as input signals at least one operating parameter of a recirculation fan of the target fuel cell system and a state parameter of an electrical state of the fuel cell stack of the target fuel cell system, and
a setting step (109) in which the activation interval determined in the determination step is set in the target fuel cell system (200) for operating the target fuel cell system (200).

2. The method (100) according to claim 1,
wherein
the machine learning system comprises a data model that mathematically maps a relationship between the input signals and a hydrogen concentration in the anode circuit of the training fuel cell system ascertained by means of the hydrogen concentration sensor.

3. The method (100) according to claim 2,
wherein
the machine learning system is configured to automatically adapt the data model during the training step (101) such that a deviation between a value of a hydrogen concentration in the anode circuit of the training fuel cell system ascertained by the machine learning system and a hydrogen concentration measured by means of the hydrogen concentration sensor is minimized.

4. The method (100) according to claim 1,
wherein
the ascertaining step (105), the determination step (107) and the setting step (109) are performed in the target fuel cell system (200) without a hydrogen concentration sensor.

5. The method (100) according to claim 1,
wherein
measured values of a pressure and/or a temperature in the anode circuit as well as a quantity of hydrogen purged out during the last purging process are also provided to the machine learning system as input signals.

6. A fuel cell system (200) comprising a control apparatus (201),
wherein the controller (201) is configured to:
execute at least part of a machine learning system that
was trained in a training step (101) by means of a training fuel cell system to ascertain a hydrogen concentration supplied to a fuel cell stack of the training fuel cell system on the basis of input signals, wherein the input signals comprise at least one operating parameter of a recirculation fan of the training fuel cell system and a state parameter of an electrical state of the fuel cell stack of the training fuel cell system,
and the hydrogen concentration ascertained by the machine learning system was validated using a hydrogen concentration ascertained by a hydrogen concentration sensor of the training fuel cell system,
wherein the machine learning system is configured to ascertain a hydrogen concentration supplied to a fuel cell stack of the target fuel cell system,
wherein the machine learning system receives as input signals at least one operating parameter of a recirculation fan of the fuel cell system and a state parameter of an electrical state of the fuel cell stack of the fuel cell system,
wherein the control apparatus (201) is configured to determine an activation interval between respective activations of a purge valve (207) of the fuel cell system (200) based on the hydrogen concentration ascertained by the machine learning system, and
to set the activation interval in the fuel cell system (200).

7. The fuel cell system (200) according to claim 6,
wherein
the fuel cell system (200) does not comprise a hydrogen concentration sensor in the anode circuit.

8. A non-transitory, computer-readable medium comprising instructions which, when executed on a computer, cause the computer to
train a machine learning model via a training fuel cell system to ascertain a hydrogen concentration supplied to a fuel cell stack of the training fuel cell system,
wherein the machine learning model receives as input signals at least one operating parameter of a recirculation fan of the training fuel cell system and one state parameter for an electrical state of the fuel cell stack of the training fuel cell system.
and in which a hydrogen concentration ascertained by the machine learning model is validated using a hydrogen concentration ascertained by a hydrogen concentration sensor of the training fuel cell system,
at least partially transfer the machine learning model trained via the training fuel cell system at least partially to a target fuel cell system,
ascertain a hydrogen concentration supplied to a fuel cell stack of the target fuel cell via the machine learning model,
determine an activation interval between respective activations of a purge valve (207) of the target fuel cell system (200) based on the hydrogen concentration,
wherein the machine learning model determines as input signals at least one operating parameter of a recirculation fan of the target fuel cell system and a state parameter of an electrical state of the fuel cell stack of the target fuel cell system, and
set the activation interval in the target fuel cell system (200) for operating the target fuel cell system (200).
